(19) United States
(12) Patent Application Publication
(10) Pub. No.: US 2013/0153555 A1
(43) Pub. Date: Jun. 20, 2013

(54) PROCESS FOR LASER MACHINING A LAYER SYSTEM HAVING A CERAMIC LAYER

(71) Applicants: STEFAN WERNER KILIANI, Essen (DE); FRANCIS-JURJEN LADRU, Berlin (DE)

(72) Inventors: STEFAN WERNER KILIANI, Essen (DE); FRANCIS-JURJEN LADRU, Berlin (DE)

(21) Appl. No.: 13/709,100

(22) Filed: Dec. 10, 2012

(30) Foreign Application Priority Data
Dec. 15, 2011 (EP) 11193801.5

(51) Int. Cl. B23K 26/00; B23K 26/38

(52) U.S. Cl. CPC B23K 26/0048; B23K 26/388
USPC 219/121.71

(57) ABSTRACT

A process of laser machining a layer system is provided. The layer system has at least one metallic substrate and an outer ceramic layer. After laser machining the layer system, a layer thickness of the outer ceramic layer is reduced by a laser process and/or a smoothing process. The laser machining includes creating a plurality of passage holes using a diffuser.

### CROSS REFERENCE TO RELATED APPLICATIONS

This application claims priority of European Patent Application No. 11193801.5 EP filed Dec. 15, 2011. All of the applications are incorporated by reference herein in their entirety.

### FIELD OF INVENTION

A process of laser machining of a layer system which has a ceramic layer is provided.

### BACKGROUND OF INVENTION

High-temperature components, such as turbine blades or vanes, have an outer ceramic layer for thermal insulation. This ceramic thermal barrier coating is applied to a metallic adhesion promoter layer or a metallic substrate. Furthermore, passage holes which lead through the ceramic layer and into or through the metallic substrate are made in such high-temperature components. In this case, it must be ensured that the outer surface of the ceramic layer does not become contaminated. This is often achieved by a masking.

### SUMMARY OF INVENTION

It is an object to provide a process of laser machining a layer system with a ceramic layer. This object is achieved by a process as claimed in the independent claim. The dependent claims list further advantageous measures which may be combined with one another, as desired, in order to achieve further advantages.

### BRIEF DESCRIPTION OF THE DRAWINGS

FIG. 1 shows a sequence of the process.

FIG. 2 shows a turbine blade or vane.

FIG. 3 shows a list of superalloys.

The figures and the description represent merely exemplary embodiments.

### DETAILED DESCRIPTION OF INVENTION

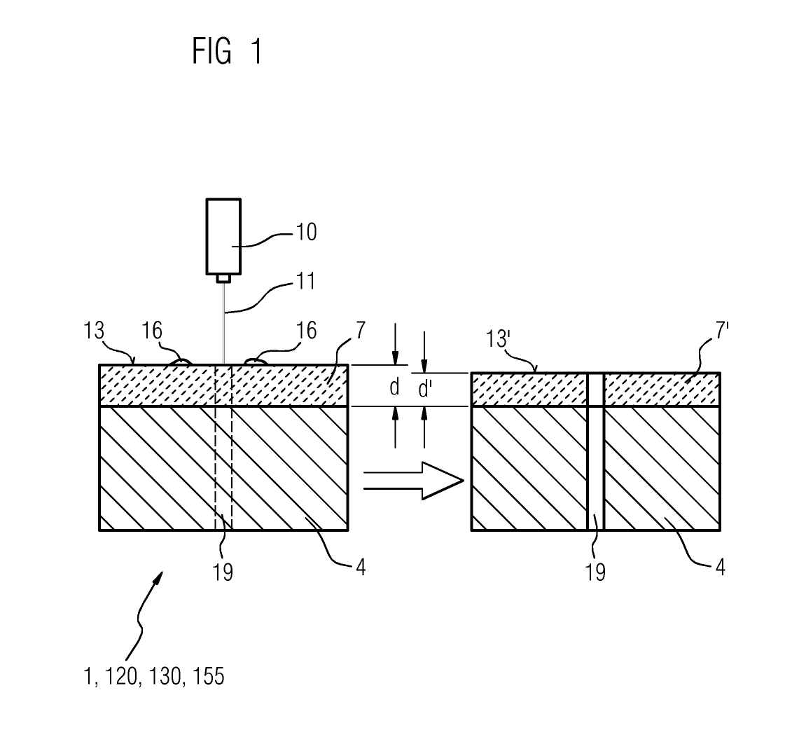

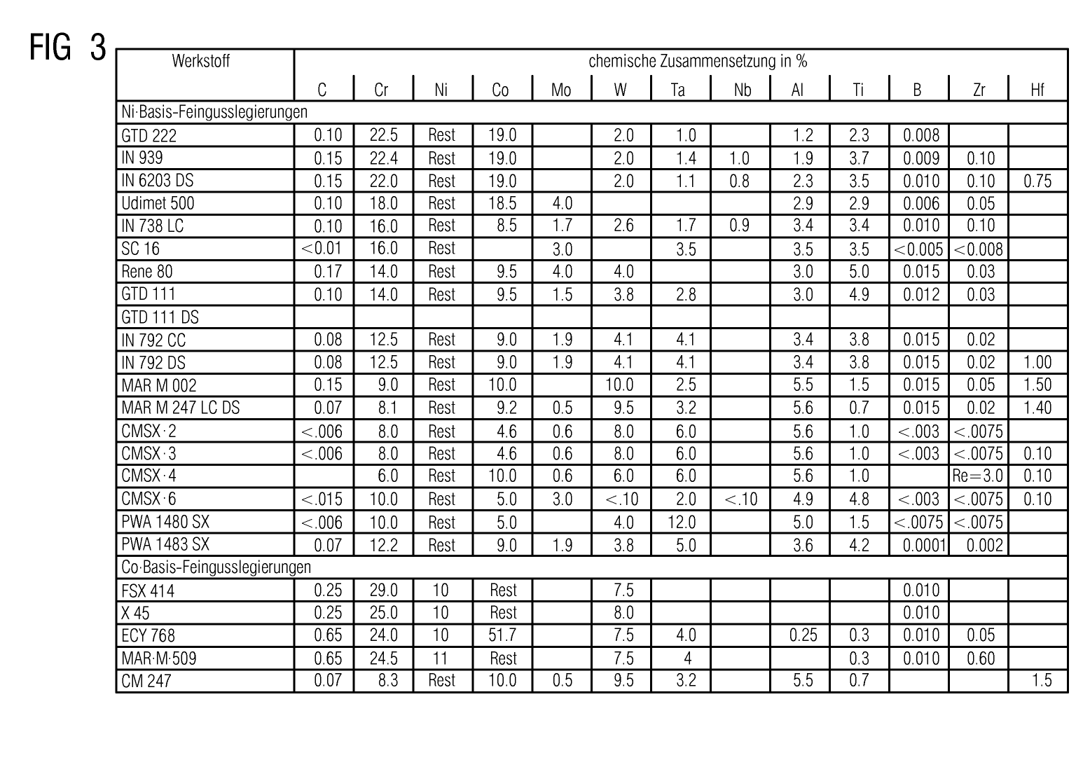

FIG. 1 shows a component 1 (120, 130, 155) as a layer system which is machined. The component 1 has a metallic substrate 4 which, particularly in the case of turbine blades or vanes, is nickel-based and/or cobalt-based, in particular as per FIG. 3.

A ceramic layer 7 or a metallic adhesion promoter layer (not shown) is present directly on the substrate 4, if appropriate with an aluminum oxide layer directly underneath the ceramic layer 7, i.e. on the substrate or on the metallic adhesion promoter layer (MCrAlX).

The ceramic layer 7 is preferably a zirconium oxide layer or a pyrochlore layer or a combination of both. Further ceramic materials are conceivable.

A hole, preferably a passage hole 19, is produced through the layer system 1, starting from the outer surface 13 of the ceramic layer 7 (as shown by dashed lines), wherein metallic material at least is removed.

The machining is effected by an energy beam, which may be an electron beam or a laser beam 11 of a laser 10. During the machining of the metallic material (adhesion promoter layer and/or substrate 4), metal splashes may deposit on the outer surface 13, which is undesirable, since these metal splashes may oxidize in later use and may damage the ceramic layer 7.

According to known methods, a powder layer is applied or some other mechanical covering is applied over a large area of the surface 13.

According to the provided method, the outer layer 7 has a thickness d which, however, is greater than the desired final dimension d′ for the layer 7′ of the finished component 1 (120, 130, 155). No maskings are used and the deposits 16 are permitted, wherein these are concomitantly removed by a reduction of the layer thickness d. The region d-d′ to be removed preferably amounts to 30 μm to 80 μm.

To change the layer thickness of the layer 7 with the layer thickness d, use can be made of a laser process or a smoothing process, so that then the surface 13′ of the layer 7′ of the end product is free of any metallic splashes 16.

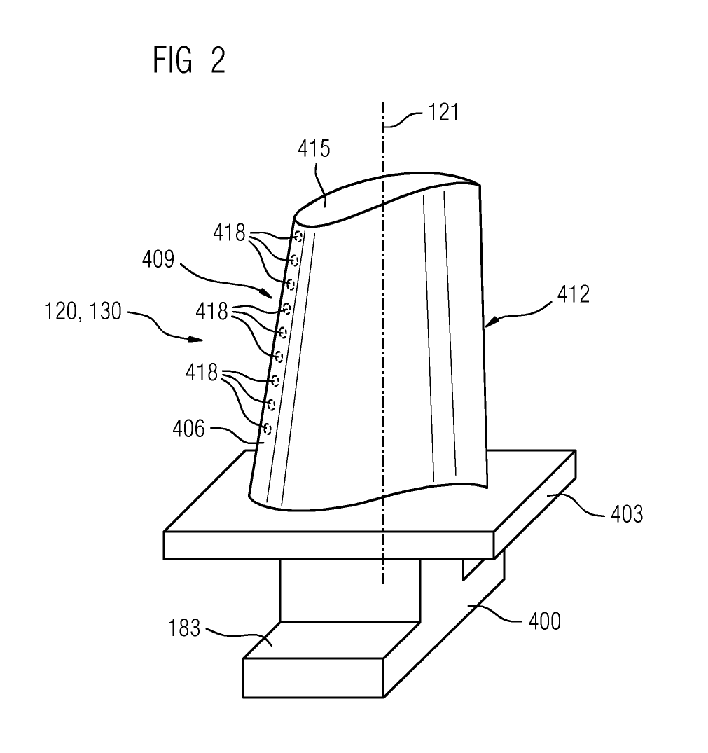

In the case of a specific component, such as a turbine blade or vane 120, 130 (see FIG. 2), it may be the case that only the main blade or vane part has cooling-air holes 19 which are produced by the laser 10. Therefore, the layer thickness of the ceramic layer 7 may be increased only locally in the region of the main blade or vane part, wherein the layer 7 already has the final dimension on the blade or vane platform.

A thicker layer 7 may be produced very easily by known coating processes such as HVOF or plasma spraying processes, because this is effected in any case by layered application and the increased layer thickness may easily be produced by a further coating layer (30 μm-80 μm).

FIG. 2 shows a perspective view of a rotor blade 120 or guide vane 130 of a turbomachine, which extends along a longitudinal axis 121. The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415. As a guide vane 130, the vane 130 may have a further platform (not shown) at its vane tip 415. A blade or vane root 183, which is used to secure the rotor blades 120, 130 to a shaft or a disk (not shown), is formed in the securing region 400. The blade or vane root 183 is designed, for example, in hammerhead form. Other configurations, such as a fir-tree or dovetail root, are possible. The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130. Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation, e.g. MCrAlX (M is at least one element selected from the group consisting of iron (Fe), cobalt (Co), nickel (Ni); X is an active element and stands for yttrium (Y) and/or silicon and/or at least one rare earth element, or hafnium (Hf). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.75i or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer, to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide. The thermal barrier coating covers the entire MCrAlX layer.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the term “comprising” does not exclude other elements or steps and the use of articles “a” or “an” does not exclude a plurality.

1. A process of laser machining a layer system, comprising:
providing a layer system with at least one metallic substrate and an outer ceramic layer,
laser machining the layer system,
reducing a layer thickness of the outer ceramic layer,
wherein the laser machining comprises creating a plurality of passage holes using a diffuser.

2. The process as claimed in claim 1, wherein a laser process is used for the reducing of the layer thickness of the outer ceramic layer.

3. The process as claimed in claim 1, wherein a smoothing process is used for reducing the layer thickness of the layer.

4. The process as claimed in claim 1, wherein the layer thickness of the outer ceramic layer is reduced by 30 μm to 80 μm.

5. The process as claimed in claim 1, wherein the laser machining of the layer system is performed without masking the outer ceramic layer.

6. The process as claimed in 2, wherein the layer thickness of the outer ceramic layer is reduced between 30 μm and 80 μm.

7. The process as claimed in claim 6, wherein the laser machining of the layer system is performed without masking the outer ceramic layer.
